(19) United States
(12) Patent Application Publication
(10) Pub. No.: US 2025/0326211 A1
(43) Pub. Date: Oct. 23, 2025

(54) MULTILAYER FILM FOR VACUUM SKIN PACKAGING, METHOD OF PACKAGING AND PACKAGES OBTAINED THEREWITH

(71) Applicant: Cryovac, LLC, Charlotte, NC (US)

(72) Inventor: Andrea Federico Fanfani, Milano (IT)

(21) Appl. No.: 18/857,862

(22) PCT Filed: Apr. 19, 2023
(86) PCT No.: PCT/EP2023/060048

§ 371 Date: Oct. 18, 2024

(30) Foreign Application Priority Data
Apr. 20, 2022 (EP) 22168955.7

(51) Int. Cl. B32B 27/08; B32B 27/30; B32B 27/32; B65B 25/00; B65B 31/04; B65D 75/30; B65D 77/20

(52) U.S. Cl. CPC B32B 27/08; B32B 27/306; B32B 27/32; B65B 25/001; B65B 31/046; B65D 75/305; B65D 77/2024; B32B 2250/24; B32B 2307/7246; B32B 2307/7376; B32B 2439/70

(57) ABSTRACT

The present invention relates to packaging films, more specifically to packaging films useful in vacuum skin packaging applications characterized by excellent oxygen barrier properties, to a method of packaging by using said films and to packages obtained therewith.

### TECHNICAL FIELD

The present invention relates to multilayer packaging films useful in vacuum skin packaging applications endowed with very high formability, machinability and abuse resistance and characterized by good to excellent gas barrier properties, especially oxygen barrier properties, which allow for a long-lasting shelf life of food products packaged therewith. The present invention further relates to a method of manufacturing said films, to a method of packaging products by using said films and to packages obtained therewith.

### BACKGROUND ART

Vacuum skin packaging (VSP) is a process well known in the art using a thermoplastic packaging material to enclose a food product. The terms “vacuum skin packaging” or “VSP” as used herein indicate that the product is packaged under vacuum and the space containing the product is evacuated from gases at the moment of packaging. The top flexible film (or web) is also referred to as “skin-forming”, “skin” or “upper” film. In the vacuum skin packaging process, an article may be placed on a rigid, semi-rigid or flexible support member, that can be flat or shaped, e.g., tray-shaped, bowl-shaped or cup-shaped (called “bottom” support or web), and the supported article is then passed to a chamber where a “top” web is first drawn upward against a heated dome and then draped down over the article. The movement of the top web is controlled by vacuum and/or air pressure, and in a vacuum skin packaging arrangement, the interior of the container is vacuumized before final welding of the top web to the bottom web. In the VSP process, the upper heated film forms a tight skin around the product and is tightly adhered to the part of the support not covered by the product.

Vacuum skin packaging is described in many references, including FR1258357, FR1286018, AU3491504, U.S. RE30009, U.S. Pat. Nos. 3,574,642, 3,681,092, 3,713,849, 4,055,672, 5,346,735, WO2009141214, EP2722279, EP2459448.

Vacuum skin packaging is commonly employed for packaging food products such as fresh and frozen meat and fish, cheese, processed meat, ready meals and the like. The final package presents a tight fitting, clear package which protects the food article from the external environment.

The demands imposed nowadays on the packaging films used in vacuum skin packaging applications are particularly high: the films have to stand the heating and stretching conditions within the vacuum chamber of the packaging machine without undergoing excessive softening and perforations, must be highly formable and, in case of ready-meals packaging, be ovenable and/or microwavable.

Good formability is highly desirable in VSP applications to ensure that the heated film adequately conforms to the shape of the packaged product, without leaving pleats on the package surfaces or without forming protruding areas of self-adhesion of the film, at the package corners or sides. This unwanted phenomenon, known as bridging or webbing, can be so marked to extend to separate forming units in the same packaging operation. Obviously, packages showing these defects in the top skin draping are not acceptable for the consumer and therefore they have to be rejected. Other important features of VSP films include optical properties, such as glossiness and haze, which contribute to an attractive package appearance.

Moreover, VSP films are also required to have gas barrier properties, in particular oxygen barrier properties. Oxygen barrier in fact is well known as a key parameter to extend the shelf life of the packaged products, as oxygen is one of the main factors responsible for food spoilage.

Ethylene and vinyl alcohol copolymers (EVOH) are commonly used to form the barrier layer in VSP films because of their sustainability, effectiveness in reducing gas (mainly oxygen) permeation within the packages, ease of use in the film manufacture process. The drawback of EVOH is that it is very sensitive to the relative humidity (RH %) of the surrounding environment: the oxygen barrier properties of a layer made of this copolymer decrease in an exponential way when the RH % of the environment surrounding the layer increases, until they are substantially lost when the environmental RH % is close to saturation. In other words, the OTR (Oxygen Transmission Rate, defined as the steady state rate at which gaseous oxygen permeates through a film or a layer at certain conditions of temperature and RH %) of EVOH barrier layers increases at increasing environmental RH % conditions.

VSP is typically used for packaging food products. When particularly “wet” products, like fresh red meat, fish or some types of ready meals are packaged, the relative humidity inside the package can be very close to, or even reach 100%. In typical storage conditions (in retailers' or supermarkets' refrigerators), the environmental relative humidity is generally about 60-70%. Therefore, some humidity can penetrate the film and reach the EVOH barrier layer, wetting it to some extent. Consequently, a decrease or even the loss of the oxygen barrier properties of the EVOH layer is to be expected.

To limit this drawback, the EVOH layer is typically sheltered by several other layers on both sides thereof; in addition, the use of very thick EVOH barrier layers (up to 10-15 microns, or even thicker) has been the solution of choice in the recent years. However, this approach is not free from drawbacks. First, increasing the number of layers in a film or the thickness of the EVOH layer requires the use of greater amounts of polymer(s), with resulting sustainability and costs issues. In addition, even thick EVOH layers may anyway reach a degree of relative humidity such that their oxygen barrier effectiveness is impaired, to the detriment of the shelf life of the packaged products. This is an issue especially for particularly perishable foodstuff or for products for which a very long shelf life is desired, such as fresh red meat.

In conclusion, there is still the need to provide VSP films capable of granting good oxygen barrier properties without the need for a high thickness of the EVOH barrier layer. There is also the need to further improve the gas barrier properties of films to be used in VSP application, to allow a longer shelf life of the packaged products. At the same time these films must be formable to withstand the condition of use of the VSP equipment. Being ovenable and/or microwavable is an additional benefit, especially when ready meals are packaged.

### SUMMARY OF THE INVENTION

Unexpectedly, it has now been found that by placing a layer of a polymer having high moisture barrier properties (such as HDPE) between the sealant layer and the EVOH gas barrier of a vacuum skin packaging film, it is possible to obtain a VSP film in which the thickness of the EVOH barrier layer may be decreased in respect to the EVOH layer thickness of currently used VSP films, or which, at comparable EVOH layer thicknesses, has improved oxygen barrier properties (i.e. a lower oxygen transmission rate, OTR). Surprisingly, the thickness of the EVOH barrier layer may be decreased e.g. by 20%, 30%, 40% or even 50% in respect to the EVOH layer thickness of currently used VSP films, with still very good oxygen barrier properties. The vacuum skin packages obtained using this film allow for a particularly extended shelf life of the food products packaged therewith.

As stated, since inside the VSP package the RH % can be up to 100% and outside the package it is typically 60-70% (storage conditions), a “humidity gradient” exists and humidity will tend to move mainly from the inside of the package towards the outside of the package.

Without wishing to be bound by any particular theory, it is thus believed that an asymmetrical layers structure on the two sides of the EVOH layer could prevent the moisture coming from the inside of the package to reach the EVOH layer, such that “dry” operating conditions of the EVOH barrier layer can be preserved, and its effectiveness is not impaired. In other words, the present invention reduces the RH % of the EVOH barrier layer in its condition of use.

Accordingly, it is a first object of the present invention a coextruded, non-oriented multilayer film suitable for use as top web in vacuum skin packaging comprising at least:
an outer sealing layer a),
an inner barrier layer c) which comprises a major proportion, preferably at least 60%, at least 70%, more preferably at least 80%, at least 90%, at least 95% by weight with respect to the weight of layer c), even more preferably which consists of an ethylene vinyl alcohol (EVOH) copolymer,
at least one inner layer b) which comprises at least 70%, at least 80%, preferably at least 90%, more preferably at least 95% by weight with respect to the weight of layer b), even more preferably which consists of one or more polymers having water vapor transmission rate (WVTR) not higher than 8 g/sqm·day, preferably not higher than 7 g/sqm·day, more preferably not higher than 6 g/sqm·day, even more preferably not higher than 4 g/sqm·day, when measured according to ASTM F-1249 at 38° C. and 90% RH, on a flat cast extruded sample having a thickness of 50 microns, and
an outer skin layer d),
   wherein:
said at least one inner layer b) is between the sealing layer a) and the barrier layer c);
no inner layers b) are present between the barrier layer c) and the outer skin layer d); and
the total thickness of the at least one inner layer b) between the sealing layer a) and the barrier layer c) is between 2% and 14%, preferably between 3% and 12%, more preferably between 4% and 10%, even more preferably between 6% and 8% of the thickness of the whole film.

A second object of the present invention is a vacuum skin package comprising a bottom support, a product loaded onto said support and a top film draped over the product and sealed over the entire surface of the support not covered by the product, wherein at least one of the support and/or the top film is a film according to the first object of the present invention. Preferably, at least the top film is a film according to the first object of the present invention.

A third object of the present invention is a vacuum skin packaging process, in which at least one of the bottom support and/or the top film is a film according to the first object of the present invention. Preferably, at least the top film is a film according to the first object of the present invention. In particular, an object of the present invention is a vacuum skin packaging process, which comprises the steps of:
providing a bottom support, optionally a bottom film according to the first object of the present invention,
disposing a product onto the support,
providing a top film comprising an outer sealing layer, optionally a film according to the first object of the present invention, in which the outer sealing layer of the top film faces the support, wherein at least one of the support and/or the top film is a film according to the first object of the present invention,
heating the top film and moulding it down upon and around the product and against the support, the space between the heated top film and the support having been evacuated to form a tight skin around the product, and
tight sealing the top film over the entire surface of the support not covered by the product by differential air pressure.

A fourth object of the present invention is the use of a film according to the first object of the present invention for vacuum skin packaging applications, preferably as a top film for vacuum skin packaging applications.

### Definitions

As used herein, the phrase “inner layer” in connection with the multilayer film refers to a layer having both its surfaces directly adhered to other layers of the film.

As used herein, the phrase “outer layer” in connection with the multilayer film refers to a layer having only one of its principal surfaces directly adhered to another layer of the film.

As used herein, the terms “sealing layer”, “sealant layer”, “heat sealable layer” refer to the outer layer of the multilayer film that in the VSP packaging process will be in contact with the food product and is involved in the sealing to form a closed package.

As used herein, the terms “skin layer” or “abuse layer” refer to the outer layer of the multilayer film that, in the final package, will be in contact with the environment and, if the film is used as a top film in the VSP packaging process, will be in contact with the heated dome.

As used herein the term “directly adhered” as applied to the layers of a multilayer film, refers to the adhesion of a first element to a second element, without any adhesive, or any other layer therebetween.

As used herein, the term “adhered” when used without the adverb “directly” broadly refers to the adhesion of a first element to a second element either with or without an adhesive, or any other layer therebetween.

As used herein, the word “between”, as applied to a layer being between two other specified layers, includes both direct adherence of such layer to the two other layers it is between, and the lack of direct adherence of such layer to either or both of the two other layers it is between, i.e., when a subject layer is between two object layers, one or more additional layers can be present between the subject layer and one or both of the object layers.

As used herein, the term “tie layer” refers to any inner layer having the primary function of adhering two layers to one another.

As used herein, the term “core layer” refers to any inner layer having a primary function other than adhering two layers to one another.

As used herein, the term “bulk layer” or “structural” layer refers to a layer generally used to improve the abuse or puncture resistance of the film or just to provide the desired thickness.

As used herein, the term “barrier” or “gas barrier” when referred to a layer, to a resin contained in said layer, or to a film, refers to the property of the layer, resin or film to limit to a certain extent the passage of gases, preferably of oxygen, through itself.

As used herein, the terms “polymer” or “(co)polymer” refers to the product of a polymerization reaction, and is inclusive of homo-polymers and co-polymers.

As used herein, the term “homo-polymer” is used with reference to a polymer resulting from the polymerization of a single type of monomer, i.e., a polymer consisting essentially of a single type of repeating unit.

As used herein, the term “copolymer” refers to a polymer resulting from the polymerization of two or more types of monomers, and includes terpolymers.

As used herein the term “polyolefin” refers to any polymerized or co-polymerized olefin that can be linear, branched, or cyclic, substituted or unsubstituted, and possibly modified. Resins such as polyethylene, ethylene-alpha-(C4-C8)olefin copolymers, ethylene-propylene copolymers, ethylene-propylene-alpha-(C4-C8)olefin ter-polymers, propylene-butene copolymer, polybutene, poly(4-methyl-pentene-1), ethylene-propylene rubber, butyl rubber, as well as copolymers of ethylene (or a higher olefin) with a comonomer which is not an olefin and in which the ethylene (or higher olefin) monomer predominates such as ethylene-vinyl acetate copolymers (EVA), ethylene-acrylic acid copolymers (EAA), ethylene-alkyl acrylate copolymers, ethylene-methacrylic acid copolymers (EMAA), ethylene-alkyl methacrylate copolymers, ethylene-alkyl acrylate-maleic anhydride copolymers, ionomers, as well the blends thereof in any proportions are all included. Also included are the modified polyolefins, where the term “modified” is intended to refer to the presence of polar groups in the polymer backbone. The above polyolefin resins can be “heterogeneous” or “homogeneous”, wherein these terms refer to the catalysis conditions employed and as a consequence thereof to the particular distribution of the molecular weight, branched chains size and distribution along the polymer backbone, as known in the art.

As used herein, the phrase “ethylene-alpha-olefin copolymer” refers to heterogeneous and to homogeneous polymers such as linear low density polyethylene (LLDPE) with a density usually in the range of from about 0.900 g/cc to about 0.930 g/cc, linear medium density polyethylene (LMDPE) with a density usually in the range of from about 0.930 g/cc to about 0.945 g/cc, and very low and ultra low density polyethylene (VLDPE and ULDPE) with a density lower than about 0.915 g/cc, typically in the range 0.868 to 0.915 g/cc, and such as metallocene-catalyzed EXACT™ and EXCEED™ homogeneous resins obtainable from Exxon, single-site AFFINITY™ resins obtainable from Dow, and TAFMER™ homogeneous ethylene-alpha-olefin copolymer resins obtainable from Mitsui. All these materials generally include copolymers of ethylene with one or more co-monomers selected from (C4-C10)-alpha-olefin such as butene-1, hexene-1, octene-1, etc., in which the molecules of the copolymers comprise long chains with relatively few side chain branches or cross-linked structures.

As used herein the term “ethylene-alpha-(C4-C8)olefin copolymers” is intended to refer to both heterogeneous and homogeneous (e.g., “single site”, or “metallocene”) materials with densities of from about 0.87 to about 0.95 g/cc.

As used herein, the phrase “heterogeneous polymer” or “polymer obtained by heterogeneous catalysis” refers to polymerization reaction products of relatively wide variation in molecular weight and relatively wide variation in composition distribution, i.e., typical polymers prepared, for example, using conventional Ziegler-Natta catalysts, for example, metal halides activated by an organometallic catalyst, i. e., titanium chloride, optionally containing magnesium chloride, complexed to trialkyl aluminum and may be found in patents such as U.S. Pat. No. 4,302,565 to Goeke et al. and U.S. Pat. No. 4,302,566 to Karol, et al. Heterogeneous catalyzed copolymers of ethylene and an-olefin may include linear low-density polyethylene, very low-density polyethylene and ultra low-density polyethylene. Some copolymers of this type are available from, for example, The Dow Chemical Company, of Midland, Michigan., U.S.A. and sold under the trademark DOWLEX resins.

As used herein, the phrase “homogeneous polymer” or “polymer obtained by homogeneous catalysis” refers to polymerization reaction products of relatively narrow molecular weight distribution and relatively narrow composition distribution. Homogeneous polymers are structurally different from heterogeneous polymers, in that homogeneous polymers exhibit a relatively even sequencing of co-monomers within a chain, a mirroring of sequence distribution in all chains, and a similarity of length of all chains, i.e., a narrower molecular weight distribution. This term includes those homogeneous polymers prepared using metallocenes, or other single-site type catalysts, as well as those homogenous polymers that are obtained using Ziegler Natta catalysts in homogenous catalysis conditions.

The co-polymerization of ethylene and alpha-olefins under homogeneous catalysis, for example, co-polymerization with metallocene catalysis systems which include constrained geometry catalysts, i.e., monocyclopentadienyl transition-metal complexes is described in U.S. Pat. No. 5,026,798 to Canich. Homogeneous ethylene/alpha-olefin copolymers (E/AO) may include modified or unmodified ethylene/alpha-olefin copolymers having a long-chain branched (8-20 pendant carbons atoms) alpha-olefin comonomer available from The Dow Chemical Company, known as AFFINITY and ATTANE resins, TAFMER linear copolymers obtainable from the Mitsui Petrochemical Corporation of Tokyo, Japan, and modified or unmodified ethylene/-olefin copolymers having a short-chain branched (3-6 pendant carbons atoms)-olefin comonomer known as EXACT resins obtainable from ExxonMobil Chemical Company of Houston, Texas, U.S.A.

As used herein the term “ionomer” designates metal salts of acidic copolymers, such as metal salts of ethylene/acrylic acid copolymers (EAA) or metal salts of ethylene/methacrylic acid copolymers (EMAA), wherein the metal cation can be an alkali metal ion, a zinc ion or other multivalent metal ions. These resins are available, for instance, from DuPont under the trade name Surlyn™.

As used herein, the term “ethylene-vinyl alcohol”, abbreviated as “EVOH” includes saponified or hydrolyzed ethylene-vinyl acetate copolymers, and refers to vinyl alcohol copolymers having an ethylene comonomer content preferably comprised from about 25 to about 48 mole %, more preferably from about 32 to about 44 mole % ethylene, and a saponification degree of at least 85%, preferably at least 90%.

As used herein, the term “polyester” refers in general to homopolymers or copolymers having an ester linkage between monomer units which may be formed, for example, by condensation polymerization reactions between a dicarboxylic acid and glycol. The ester monomer unit may be represented by the general chemical formula: R—C(O)O—R′ where R and R′=an alkyl group and may be generally formed from the polymerization of dicarboxylic acid and diol monomers or monomers containing both carboxylic acid and hydroxy moieties. The dicarboxylic acid may be linear or aliphatic, i.e., oxalic acid, malonic acid, succinic acid, glutaric acid, adipic acid, pimelic acid, suberic acid, azelaic acid, sebacic acid, and the like; or may be aromatic or alkyl-substituted aromatic acids, i.e., various isomers of phthalic acid, such as paraphthalic acid (or terephthalic acid), isophthalic acid and naphthalic acid. Specific examples of alkyl-substituted aromatic acids include the various isomers of dimethylphthalic acid, such as dimethylisophthalic acid, dimethylorthophthalic acid, dimethylterephthalic acid, the various isomers of diethylphthalic acid, such as diethylisophthalic acid, diethylorthophthalic acid, the various isomers of dimethylnaphthalic acid, such as 2,6-dimethylnaphthalic acid and 2,5-dimethylnaphthalic acid, and the various isomers of diethylnaphthalic acid. The glycols may be straight-chained or branched. Specific examples include ethylene glycol, propylene glycol, trimethylene glycol, 1,4-butane diol, neopentyl glycol and the like. The polyalkyl terephthalates are aromatic esters having a benzene ring with ester linkages at the 1,4-carbons of the benzene ring as compared to polyalkyl isophthalates, where two ester linkages are present at the 1,3-carbons of the benzene ring. In contrast, polyalkyl naphthalates are aromatic esters having two fused benzene rings where the two ester linkages may be present at the 2,3-carbons or the 1,6-carbons.

As used herein, the phrase “modified polymer”, as well as more specific phrases such as “modified ethylene/vinyl acetate copolymer”, and “modified polyolefin” refer to such polymers having an anhydride functionality, as defined immediately above, grafted thereon and/or copolymerized therewith and/or blended therewith. Preferably, such modified polymers have the anhydride functionality grafted on or polymerized therewith, as opposed to merely blended therewith. As used herein, the term “modified” refers to a chemical derivative, e.g. one having any form of anhydride functionality, such as anhydride of maleic acid, crotonic acid, citraconic acid, itaconic acid, fumaric acid, etc., whether grafted onto a polymer, copolymerized with a polymer, or blended with one or more polymers, and is also inclusive of derivatives of such functionalities, such as acids, esters, and metal salts derived therefrom. As used herein, the phrase “anhydride-containing polymer” and “anhydride-modified polymer”, refer to one or more of the following: (1) polymers obtained by copolymerizing an anhydride-containing monomer with a second, different monomer, and (2) anhydride grafted copolymers, and (3) a mixture of a polymer and an anhydride-containing compound.

As used herein the term “polyamide” refers to high molecular weight polymers having amide linkages along the molecular chain, and refers more specifically to synthetic polyamides such as nylons. Such term encompasses both homo-polyamides and co- (or ter-) polyamides. It also specifically includes aliphatic polyamides or co-polyamides, aromatic polyamides or co-polyamides, and partially aromatic polyamides or co-polyamides, modifications thereof and blends thereof. The homo-polyamides are derived from the polymerization of a single type of monomer comprising both the chemical functions which are typical of polyamides, i.e. amino and acid groups, such monomers being typically lactams or aminoacids, or from the polycondensation of two types of polyfunctional monomers, i.e. polyamines with polybasic acids. The co-, ter-, and multi-polyamides are derived from the copolymerization of precursor monomers of at least two (three or more) different polyamides. As an example, in the preparation of the co-polyamides, two different lactams may be employed, or two types of polyamines and polyacids, or a lactam on one side and a polyamine and a polyacid on the other side. Exemplary polymers are polyamide 6, polyamide 6/9, polyamide 6/10, polyamide 6/12, polyamide 11, polyamide 12, polyamide 6/12, polyamide 6/66, polyamide 66/6/10, modifications thereof and blends thereof. Said term also includes crystalline or partially crystalline, aromatic or partially aromatic polyamides such as polyamide 61/6T or polyamide MXD6.

As used herein, the phrase “amorphous polyamide” refers to polyamides or nylons with an absence of a regular three-dimensional arrangement of molecules or subunits of molecules extending over distances, which are large relative to atomic dimensions. However, regularity of structure exists on a local scale. See, “Amorphous Polymers,” in Encyclopedia of Polymer Science and Engineering, 2nd Ed., pp. 789-842 (J. Wiley & Sons, Inc. 1985). This document has a Library of Congress Catalogue Card Number of 84-19713. In particular, the term “amorphous polyamide” refers to a material recognized by one skilled in the art of differential scanning calorimetry (DSC) as having no measurable melting point (less than 0.5 cal/g) or no heat of fusion as measured by DSC using ASTM D 3418. Such nylons include those amorphous nylons prepared from condensation polymerization reactions of diamines with dicarboxylic acids. For example, an aliphatic diamine is combined with an aromatic dicarboxylic acid, or an aromatic diamine is combined with an aliphatic dicarboxylic acid to give suitable amorphous nylons.

As used herein, terms identifying polymers, such as “polyamide”, “polyester”, etc. are in general inclusive of not only polymers comprising repeating units derived from monomers known to polymerize to form a polymer of the named type, but are also inclusive of comonomers, derivatives, etc. which can copolymerize with monomers known to polymerize to produce the named polymer. For example, the term “polyamide” encompasses both polymers comprising repeating units derived from monomers, such as caprolactam, which polymerize to form a polyamide, as well as copolymers derived from the copolymerization of caprolactam with a comonomer which when polymerized alone does not result in the formation of a polyamide.

As used herein, the terms “major amount” or “major proportion” refer to an amount of a component higher than 50% by weight in respect of the total amount by weight of the components of a referred element (e.g. a film, a layer etc.).

As used herein, the terms “minor amount” or “minor proportion” refer to an amount of a component lower than 50% by weight in respect of the total amount by weight of the components of a referred element (e.g. a film, a layer etc.).

As used herein, the term “extrusion” is used with reference to the process of forming continuous shapes by forcing a molten plastic material through a die, followed by cooling (quenching) or chemical hardening. Immediately prior to extrusion through the die, the relatively high-viscosity polymeric material may be fed into a rotating screw of variable pitch, i.e., an extruder, which forces the polymeric material through the die.

As used herein, the term “coextrusion” refers to the process of extruding two or more materials through a single die with two or more orifices arranged so that the extrudates merge and weld together into a laminar structure before chilling, i.e., quenching. The term “coextrusion” as used herein also includes “extrusion coating”.

As used herein, the term “extrusion coating” refers to processes by which a “coating” of molten polymer(s), comprising one or more layers, is extruded onto a solid “substrate film” in order to coat the substrate film with the molten polymer coating to bond the substrate and the coating together, thus obtaining a complete film.

As used herein, the phrases “longitudinal direction” and “machine direction”, also abbreviated “LD” and “MD”, respectively, refer to the direction “along the length” of the film, i.e., the direction of the film as it is formed during coextrusion. When referred to packages, they relate to their motion direction in the packaging equipment.

As used herein, the phrases “transverse direction” or “crosswise direction”, herein also abbreviated “TD”, refers to the direction across the film, perpendicular to the machine or longitudinal direction. When referred to packages, they relate to their motion direction in the packaging equipment.

As used herein, the term “not heat-shrinkable” refers to a film characterized by a total free shrink percentage (i.e. the sum of free shrink percentage in LD and TD directions) measured in oil at 160° C. according to ASTM D2732 test method lower than 20% or 15%, preferably lower than 10%.

As used herein, the phrase “film suitable for use as top web in vacuum skin packaging” refers to a thermoplastic film which is suitable for use in a VSP process, namely a film able to stand heating and stretching conditions within the vacuum chamber of the packaging machine without undergoing perforations and excessive softening and, afterwards, is able to tightly adhere to the surface of the support. Preferably, a film for use as a top web in VSP applications is characterized by high formability and sealability.

As used herein the term “support”, as applied to vacuum skin packages, means the bottom part of the VSP package into which the product is accommodated and onto which the top skin film is sealed for the part that is not covered by the product. The support can be flat or shaped, i.e. tray-shaped, rigid, semi-rigid or flexible. The support may be an optionally perforated, in-line thermoformed bottom or an off-line pre-made tray.

As used herein the term “microwavable” when used in connection with the films or the VSP packages of the present invention, refers to those structures that are “substantially microwave transparent” as well as those that are “microwave active”. While substantially microwave-transparent are those capable of being crossed by at least 80%, preferably at least 90% of the microwaves generated by a microwave oven without any sort of interference therewith, the microwave-active are those that incorporate microwave reflective components intended to modify the energy deposition within the adjacent foodstuff. To be “microwaveable” in both cases, under the conditions of use, the packaging material should not be degraded or deformed and it should not release more than 60 ppm of global contaminants to the packaged food in contact therewith. In practice, packaging materials that withstand a heat treatment at 121° C. for 30 min (conditions that are drastic enough not to be reached normally in microwave cooking) without deforming and releasing less than 60 ppm of contaminants, are considered to be “microwaveable” according to most of the food laws.

As used herein, the Water Vapor Transmission Rate (WVTR) of a film or a layer is the steady state rate at which water vapor permeates through said film or layer at specified conditions of temperature and relative humidity (% RH). WVTR values are expressed in g/sqm·day in SI units.

### DETAILED DESCRIPTION OF THE INVENTION

While the invention will be described in connection with one or more preferred embodiments, it will be understood that it is not limited to these embodiments. On the contrary, the invention includes all alternatives, modifications, and equivalents as may be included within the scope of the appended claims.

The percentages are percentages by weight unless otherwise stated.

It is a first object of the present invention a coextruded, non-oriented multilayer film suitable for use as top web in vacuum skin packaging comprising at least:
an outer sealing layer a),
an inner barrier layer c) which comprises a major proportion, preferably at least 60%, at least 70%, more preferably at least 80%, at least 90%, at least 95% by weight with respect to the weight of layer c), even more preferably which consists of an ethylene vinyl alcohol (EVOH) copolymer,
at least one inner layer b) which comprises at least 70%, at least 80%, preferably at least 90%, more preferably at least 95% by weight with respect to the weight of layer b), even more preferably which consists of one or more polymers having water vapor transmission rate (WVTR) not higher than 8 g/sqm·day, preferably not higher than 7 g/sqm·day, more preferably not higher than 6 g/sqm·day, even more preferably not higher than 4 g/sqm·day, when measured according to ASTM F-1249 at 38° C. and 90% RH, on a flat cast extruded sample having a thickness of 50 microns, and
an outer skin layer d),
   wherein:
said at least one inner layer b) is between the sealing layer a) and the barrier layer c);
no inner layers b) are present between the barrier layer c) and the outer skin layer d), and
the total thickness of the at least one inner layer b) between the sealing layer a) and the barrier layer c) is between 2% and 14%, preferably between 3% and 12%, more preferably between 4% and 10%, even more preferably between 6% and 8% of the thickness of the whole film.

The sealing layer a) is the outer layer of the multilayer film that in the VSP packaging process will be in contact with the food product and, if the film is used as the VSP top film, will be sealed to the support.

The sealing layer a) comprises polymers generally used for this purpose in the art of VSP films, typically polyolefins characterized by low glass transition temperature (Tg) values. As used herein, the glass transition temperature (Tg) is the midpoint glass transition temperature measured by differential scanning calorimetry (DSC) according to ASTM D 3418.

Suitable polymers for the sealing layer a) may be ethylene homo- or co-polymers, like LLDPE, LDPE, VLDPE, ethylene/alpha-olefin copolymers, ethylene/acrylic acid copolymers, ethylene/methacrylic acid copolymers, or ethylene/vinyl acetate copolymers, ionomers and their blends.

Preferred polymers for the sealing layer a) are VLDPE, LLDPE, LDPE, ionomers, ethylene-vinyl acetate copolymers, ethylene-propylene copolymers and blends thereof.

Preferably, the sealing layer a) comprises a major proportion, preferably at least 60%, 70%, 80%, 90%, 95%, 98% by weight with respect to the weight of layer a) of one or more of the above polymers. More preferably, the sealing layer a) consists of one or more of the above polymers.

Examples of suitable resins for the outer sealing layer (a) are ethylene-propylene copolymer VERSIFY 3000 (DOW), ethylene-vinyl acetate copolymers ESCORENE FL00212 and ESCORENE ULTRA FL 00728CC (Exxon Mobil), low-density polyethylene such as LD259 (Exxon Mobil), zinc-neutralized ethylene (meth)acrylic acid copolymers such as those marketed by Dow under the tradename Surlyn, for example Surlyn 1702.

In addition to the sealing properties, layer (a) may have adhesive properties.

In fact, as the adhesion of the top web to the support may, at least partially, be based on sticking of the two surfaces and not only on welding, also polymers which are commonly considered to be scarcely sealable but having a sufficient stickiness with respect to the support may be used as additional or only components of layer a) as well.

When the present film is used as the top film in VSP, the person skilled in the art will be able to select the best components for the sealing layer a) in order to get a sufficiently high adhesion, depending on the nature of the bottom support to which it is sealed.

When a top film capable of sealing onto a (co)polyester bottom web is desired, the sealing layer a) may comprise one or more (co)polyesters, advantageously one or more (co)polyesters having a glass transition temperature (Tg) not higher than 50° C., preferably than 35° C., more preferably than 20° C. and/or a melting point temperature (Tm) not higher than 170° C., preferably than 160° C., more preferably than 150° C. A polyester-based sealant layer is described in WO 2017/153439 A1 in the name of Cryovac, Inc.

The sealing layer a) may advantageously comprise antiblock and/or slip additives as known in the art. The total amount of these additives can typically range from 0.01-2.0 wt %, preferably from 0.02-1.0 wt %, even more preferably from 0.03-0.5 wt % in respect to the weight of the sealing layer a).

Generally, antiblock additives are inorganic substances, silica being the most preferred. Such inorganic fillers include conventional inorganic fillers, and particularly metal or metalloid oxides, such as alumina, silica (especially precipitated or diatomaceous silica and silica gels) and titanium dioxide, calcined clay and alkaline metal salts, such as the carbonates and sulphates of calcium and barium. Preferred particulate inorganic fillers include titanium dioxide and silica.

Slip additives typically belong to the chemical family of the amides, oleamide and erucamide being those of most common and widespread use.

The thickness of the sealing layer can range from 1 to 25 microns, preferably from 2 to 20 microns, more preferably from 3 to 15 microns, even more preferably from 6 to 18 microns.

The thickness of the sealing layer in relative percentage vs. the thickness of the whole films can range from 2 to 25%, preferably from 3% to 20%, more preferably 4 to 16%, even more preferably from 5 to 14%, most preferably from 6 to 13%.

When the films according to the present invention are used as top films in VSP, their sealing layer a) advantageously allows during the vacuum skin packaging cycle to set up a dome temperature lower than 220° C., than 210° C., than 200°, than 190° C., than 180° C., than 170° C., than 160° C., even lower than 150° C. or as low as 140° C. or lower than 140° C.

The multilayer film of the invention comprises at least one inner gas barrier layer c).

The inner gas barrier layer c) comprises a major proportion, preferably at least 60%, at least 70%, more preferably at least 80%, at least 90%, at least 95% by weight with respect to the weight of layer c), of an ethylene vinyl alcohol (EVOH) copolymer. Even more preferably, the inner gas barrier layer c) consists of EVOH, i.e. EVOH is the only component of the gas barrier layer.

Other polymers which may be present in the barrier layer c) may be polyamides, polyesters, and blends thereof, polyamides being the preferred ones.

The total amount of these other polymers in layer c) is a minor amount, preferably lower than 40%, lower than 30%, more preferably lower than 20%, lower than 10%, lower than 5% by weight with respect to the weight of layer c).

More preferably, the inner gas barrier layer c) does not comprise any other polymers further to EVOH.

In the films of the invention, typically when EVOH is employed as the only gas-barrier material, the thickness of this layer is comprised between 3 and 14 microns, preferably between 4 and 12 microns, more preferably between 5 and 10 microns. Advantageously, in the films of the present invention the thickness of the gas barrier layer can be lower than the thickness of the gas barrier layer of known and commonly employed VSP films. Anyway, barrier layers with a comparable or even higher thickness may be used if desired or if an even lower OTR is needed.

In the films of the invention, the total thickness of the gas barrier layer(s) c) in relative percentage vs. the thickness of the whole films can range from 3 to 10%, preferably from 4 to 7%.

EVOH copolymers with a mol % ethylene lower than the EVOH copolymers typically used in gas barrier films which have to withstand humid conditions may suitably be employed in the barrier layer c) of the present films. For example, EVOH copolymers with a mol % ethylene lower than 44%, preferably lower than 40%, even more preferably lower than 38% may be used. In an embodiment, EVOH copolymers with a mol % ethylene of about 38% may be used. In another embodiment, EVOH copolymers with about 32 mol % ethylene may be used.

Generally, in humid environments EVOH copolymers with high mol % ethylene (typically higher than 44%) are typically used, as their OTR is less affected by humidity and thus show good oxygen barrier properties even in humid conditions. In the films of the present invention, good oxygen barrier properties (i.e. low oxygen permeability) can be advantageously achieved even using EVOH copolymers with a lower mol % ethylene, such as 38% or 32%. Anyway, EVOH copolymers with a mol % ethylene higher than 38%, such as for example 44% or 48% may be used if desired.

Exemplary EVOH resins suitable for use in the films of the present invention are EVAL F101B (32 mol % ethylene), E171B (44 mol % ethylene), and EVAL G156B (48 mol % ethylene) by Evalca/Kuraray; SOARNOL ET3803 (38 mol % ethylene) and SOARNOL AT4403 (44 mol % ethylene) by Nippon Gohsei; EVASIN EV3251F (32 mol % ethylene) and EV3851V (38 mol % ethylene) by Chang Chun Petrochemicals Ltd (CCP).

In a preferred embodiment, the films of the invention comprise one gas barrier layer c) only, comprising a major proportion, preferably at least 60%, at least 70%, more preferably at least 80%, at least 90%, at least 95% by weight with respect to the weight of layer c), of EVOH, even more preferably consisting of EVOH.

Alternatively, more than one gas barrier layers c) may be present, optionally directly adhered to one another. Preferably, such more than one gas barrier layers c) independently comprise a major proportion, preferably at least 60%, at least 70%, more preferably at least 80%, at least 90%, at least 95% by weight with respect to the weight of each barrier layer c), of EVOH, even more preferably such more than one gas barrier layers consist of EVOH.

In other embodiments, a gas barrier layer c) as described above may be sandwiched between two polyamide layers.

The multilayer film of the invention comprises at least one inner layer b).

In the films of the present invention, such at least one inner layer b) is positioned between the sealing layer a) and the barrier layer c). Preferably, it can be directly adhered to the sealing layer a).

The inner layer b) comprises at least 70%, at least 80%, preferably at least 90%, more preferably at least 95% by weight with respect to the weight of layer b), of one or more polymers having water vapor transmission rate (WVTR) not higher than 8 g/sqm·day, preferably not higher than 7 g/sqm·day, more preferably not higher than 6 g/sqm·day, even more preferably not higher than 4 g/sqm·day, when measured according to ASTM F-1249 at 38° C. and 90% RH, on a flat cast extruded sample having a thickness of 50 microns.

A suitable instrument for this measurement is for example Mocon Permatran W 700.

Preferred polymers having the above indicated WVTR values are selected among high-density polyethylene (HDPE), cyclic olefin copolymers (COC), polypropylene (PP) and mixtures thereof.

Accordingly, the inner layer b) preferably comprises at least 70%, at least 80%, preferably at least 90%, more preferably at least 95% by weight with respect to the weight of layer b), of one or more polymers selected among HDPE, COC, PP and mixtures thereof.

As used herein, “high-density polyethylene”, also abbreviated “HDPE”, indicates polyethylene homo- or co-polymers with a density typically ranging from 930 to 970 kg/cubic meter. Exemplary HDPE resins suitable for use in the films of the present invention are RIGIDEX HD6070FA from INEOS, Olefins & polymers Europe, Lumicene MPE M 6040 from Total Petrochemicals, and F0863 from Sabic.

As used herein, the term “cyclic olefin copolymer”, or “cycloolefin copolymer”, also abbreviated “COC”, refers to copolymers of cyclic olefins (cycloolefins) and alpha-olefins, preferably ethylene-alpha-olefins. Suitable cyclic olefins for copolymerisation are monocyclic or multicyclic, preferably bicyclic cycloolefins, in which the rings preferably have 3 to 6 ring members. In multicyclic cycloolefins, preferably only one ring is a cycloolefinic ring whereas the other rings are cycloalkyl rings. The cycloolefin or cycloolefinic part of the multicycled cycloolefin is preferably a cyclo pentene or cyclohexene ring. Most preferably, the cycloolefin is norbornene. Suitable alpha-olefins for copolymerisation may have from 2 to 20 carbon atoms, but ethylene and propylene are preferred. Exemplary cyclic olefin copolymers are ethylene-norbornene copolymers marketed by TICONA under the name TOPAS.

As used herein, “polypropylene”, also abbreviated “PP” includes both polypropylene homopolymers resulting from polymerization of propylene repeating units, and polypropylene copolymers, resulting from co-polymerization of propylene with other repeating units, generally with ethylene. Exemplary PP resins suitable for use in the films of the present invention are RB307MO by Borealis and HP525J by Lyondell Basell Industries.

In an embodiment, the inner layer b) comprises at least 70%, at least 80%, preferably at least 90%, more preferably at least 95% by weight with respect to the weight of layer b), of HDPE.

In an embodiment, the inner layer b) comprises at least 70%, at least 80%, preferably at least 90%, more preferably at least 95% by weight with respect to the weight of layer b), of COC.

In an embodiment, the inner layer b) comprises at least 70%, at least 80%, preferably at least 90%, more preferably at least 95% by weight with respect to the weight of layer b), of PP.

Preferably, the inner layer b) consists of one or more polymers having water vapor transmission rate (WVTR) not higher than 8 g/sqm·day, preferably not higher than 7 g/sqm·day, more preferably not higher than 6 g/sqm·day, even more preferably not higher than 4 g/sqm·day, when measured according to ASTM F-1249 at 38° C. and 90% RH, on a flat cast extruded sample having a thickness of 50 microns.

In a preferred embodiment, the inner layer b) consists of one or more polymers selected among HDPE, COC, PP and mixtures thereof.

In an embodiment, the inner layer b) consists of HDPE. In another embodiment, the inner layer b) consists of COC. In still another embodiment, the inner layer b) consists of PP.

Further to polymers having the WVTR as stated above, preferably being HDPE, COC, PP, other polymers which may be present in the inner layer b) are for example ethylene homo- and co-polymers other than HDPE, e.g. low density polyethylene, ethylene-vinyl acetate copolymers, linear low density polyethylenes, linear very low density polyethylenes and ionomers, preferably ethylene-vinyl acetate copolymers.

The total amount of these polymers in the inner layer b) is lower than 30%, lower than 20%, preferably lower than 10%, more preferably lower than 5% by weight with respect to the weight of layer b).

In an embodiment, the inner layer b) does not comprise any other polymers further to those having the WVTR as stated above, optionally does not comprise other polymers further to HDPE, COC, PP, or mixtures thereof. In an embodiment, the inner layer b) does not comprise any other polymers further to HDPE.

Without wishing to be bound by theory, the inner layer b) positioned between the sealing layer a) and the barrier layer c) in the films of the invention is responsible for creating the asymmetrical structure on the two sides of the EVOH layer, (i.e. towards the inside and towards the outside of the final package comprising such films) which preserves the dry conditions of the EVOH layer. In fact, as discussed below, in the films of the present invention a layer b) is not present between the barrier layer c) and the outer skin layer d).

In an embodiment, only one inner layer b) is present in the films of the invention and is between the sealant layer a) and the barrier layer c).

In other embodiments, more than one inner layer b) may be present between the sealant layer a) and the barrier layer c). Preferably, a barrier layer b) is directly adhered to the sealant layer a).

The films of the present invention may comprise an inner layer b) positioned between the sealant layer a) and the barrier layer c) and directly adhered to the barrier layer c). No inner layers b) are present between the barrier layer c) and the outer skin layer d) of the films.

The total thickness of the one or more inner layer(s) b) between the sealant layer a) and the barrier layer c) can range from 4 to 20 microns, preferably from 5 to 16 microns. For example, the total thickness of the inner layer(s) b) can be 8 microns, or 9 microns, or 10 microns, or 15 microns.

The total thickness of the one or more inner layer(s) b) between the sealing layer a) and the barrier layer c), expressed in relative percentage vs. the thickness of the whole film, can range from 2 to 14%, preferably from 3% to 12%, more preferably from 4 to 10%, even more preferably from 6% to 8%.

The ratio between the total thickness of the one or more inner layers b) between the sealant layer a) and the barrier layer c) and the thickness of the barrier layer c) is between 0.5 and 2.8, preferably between 0.8 and 2.4, more preferably between 1 and 1.8. The person skilled in the art can adjust the respective thicknesses of the barrier layer c) and of the one or more inner layers b) between the sealant layer a) and the barrier layer c) to obtain the OTR desired for a certain film.

The multilayer film of the invention comprises an outer skin layer (or “abuse” layer) d), which in the final package will be in contact with the environment and, if the film is used as a top film in the VSP process, will be in contact with the heated dome of the vacuum chamber.

The outer skin layer typically comprises one or more polymer(s) selected from the group consisting of polyolefins and their copolymers, polyamides, polyesters and styrene-based polymers.

In one embodiment, the outer skin layer d) may comprise a minor proportion, preferably less than 40%, more preferably less than 30%, less than 20%, less than 10%, less than 5% by weight with respect to the weight of the skin layer d), of one or more polymers having water vapor transmission rate (WVTR) not higher than 8 g/sqm·day, preferably not higher than 7 g/sqm·day, more preferably not higher than 6 g/sqm·day, even more preferably not higher than 4 g/sqm·day, when measured according to ASTM F-1249 at 38° C. and 90% RH, on a flat cast extruded sample having a thickness of 50 microns. The outer skin layer d) may comprise no polymers having WVTR values as disclosed above.

For example, the outer skin layer d) may comprise a minor proportion, preferably less than 40%, more preferably less than 30%, less than 20%, less than 10%, less than 5% by weight with respect to the weight of the skin layer d) of polymers selected among HDPE, COC, PP or mixtures thereof.

In another embodiment, the outer skin layer d) may comprise a major proportion, preferably at least 70%, at least 80%, preferably at least 90%, more preferably at least 95% by weight with respect to the weight of the skin layer d), of one or more polymers having WVTR values as disclosed above. The outer skin layer d) may also consist of polymers having WVTR values as disclosed above.

For example, the outer skin layer d) may comprise a major proportion, preferably at least 70%, at least 80%, preferably at least 90%, more preferably at least 95% by weight with respect to the weight of the skin layer d), of polymers selected among HDPE, COC, PP or mixtures thereof. The outer skin layer d) may also consist of polymers selected among HDPE, COC, PP or mixtures thereof.

In the embodiments where the skin layer d) comprises a major proportion of polymers having WVTR values as disclosed above, or consists of such polymers, the skin layer d) has a thickness not higher than 7 microns, preferably not higher than 6 microns, more preferably not higher than 5 microns.

For example, the skin layer d) may be the same as the inner layer b) between the sealant layer a) and the barrier layer c). Also in this embodiment, the skin layer d) has a thickness not higher than 7 microns, preferably not higher than 6 microns, more preferably not higher than 5 microns.

In the embodiments where the skin layer d) comprises a major proportion of polymers having WVTR values as disclosed above, or consists of such polymers, optionally selected among HDPE, COC, PP and mixtures thereof, the ratio between the thickness of such layer d) and the thickness of the inner layer(s) b) positioned between the sealant layer a) and the barrier layer c) is lower than 0.6, preferably lower than 0.5, more preferably lower than 0.4.

Still without wishing to be bound by theory, the outer skin layer d) may avoid that the residual moisture moving through the film following the gradient from the inside of the package towards the outside remains entrapped within the film, rather it may allow moisture to escape from the film, being evaporated. This also may help the barrier layer to remain as “dry” as possible, increasing its OTR performances.

In some embodiments, the outer skin layer d) may comprise a major proportion, or a minor proportion, or may consist of one or more polymer(s) selected from the group consisting of polyolefins and their copolymers, polyamides, (co)polyesters, styrene-based polymers and their admixtures. Exemplary polymers for the skin layer d) are ethylene homo- and co-polymers, in particular low-density polyethylene (LDPE) and ethylene vinyl acetate copolymers, ionomers, polyamides, (co)polyesters, i.e. PET-G, or styrene-based polymer and their admixtures.

“Polyolefin”, in the context of the outer skin layer d), refers to any polymerized or co-polymerized olefin that can be linear, branched, or cyclic, substituted or unsubstituted, and possibly modified. Resins such as polyethylene, ethylene-alpha-(C4-C8)olefin copolymers, ethylene-propylene copolymers, ethylene-propylene-alpha-(C4-C8)olefin ter-polymers, propylene-butene copolymer, polybutene, poly(4-methyl-pentene-1), ethylene-propylene rubber, butyl rubber, as well as copolymers of ethylene (or a higher olefin) with a comonomer which is not an olefin and in which the ethylene (or higher olefin) monomer predominates such as ethylene-vinyl acetate copolymers, ethylene-acrylic acid copolymers, ethylene-alkyl acrylate copolymers, ethylene-methacrylic acid copolymers, ethylene-alkyl methacrylate copolymers, ethylene-alkyl acrylate-maleic anhydride copolymers, ionomers, as well the blends thereof in any proportions are all included. Also included are the modified polyolefins, where the term “modified” is intended to refer to the presence of polar groups in the polymer backbone. The above polyolefin resins can be “heterogeneous” or “homogeneous”, wherein these terms refer to the catalysis conditions employed and as a consequence thereof to the particular distribution of the molecular weight, branched chains size and distribution along the polymer backbone, as known in the art.

Exemplary suitable LDPE resins for the outer skin layer are LD259 and LD158BW from ExxonMobil. A suitable MDPE is DOWLEX SC2108G by Dow. Exemplary suitable ionomers are Surlyn 1601 and Surlyn 1650 (DuPont).

The term “polyamides”, in the context of the outer skin layer d), includes aliphatic homo- or co-polyamides commonly referred to as e.g. polyamide 6, polyamide 69, polyamide 610, polyamide 612, polyamide 11, polyamide 12, polyamide 6/12, polyamide 6/66, polyamide 66/610, modifications thereof and blends thereof. Said term also includes crystalline or partially crystalline, aromatic or partially aromatic, polyamides, such as polyamide 61/6T or polyamide MXD6.

Crystalline polyamides for the film of the present invention are those polyamides whose melting point is preferably within the range from about 130 to 230° C., more preferably from about 160 to 220° C., even more preferably from about 185 to 210° C. Suitable crystalline polyamides comprise crystalline homo-polyamides and co- (or ter-) polyamides, preferably selected among PA6; PA6.6; PA6.66; PA66.6; PA6.12; PA6.66.12; PA12; PA11; PA6.9; PA6.69; PA6.10; PA10.10; PA66.610; PA MXD6/MXDI, more preferably selected among PA6; PA6.66; PA66.6; PA6.12; PA6.66.12; PA12; PA11; PA6.9; PA MXD6/MXDI, even more preferably among PA6; PA6.66; PA6.12; PA6.66.12; PA12; PA11, most preferably being said crystalline polyamide PA6.66, and blends thereof.

The term “polyesters” in the context of the outer skin layer d), refers to polymers obtained by the polycondensation reaction of dicarboxylic acids with dihydroxy alcohols. Suitable dicarboxylic acids are, for instance, terephthalic acid, isophthalic acid, 2,6-naphthalene dicarboxylic acid and the like. Suitable dihydroxy alcohols are for instance ethylene glycol, diethylene glycol, 1,4-butanediol, 1,4-cyclohexanedimethanol and the like. Examples of useful polyesters include poly(ethylene 2,6-naphtalate), poly(ethylene terephthalate), and copolyesters obtained by reacting one or more dicarboxylic acids with one or more dihydroxy alcohols, such as PETG which is an amorphous co-polyesters of terephthalic acid with ethylene glycol and 1,4-cyclohexanedimethanol.

Preferably, suitable polyesters for the outer skin layer d) have a Tg higher than 70° C., than 75° C. or than 77° C. A suitable polyester is for example Eastar PETG 6763 by Eastman.

As used herein, the phrase “styrene-based polymer” in the context of the outer skin layer d), refers to at least one polymer selected from the group consisting of polystyrene, styrene-ethylene-butylene-styrene copolymer, styrene-butadiene-styrene copolymer, styrene-isoprene-styrene copolymer, styrene-ethylene-butadiene-styrene copolymer, and styrene-(ethylene-propylene rubber)-styrene copolymer. As used herein the use of a “dash” (i.e., the “-”) in a styrene-based polymer formula, is inclusive of both block copolymers and random copolymers. More particularly, the phrase “styrene-based polymer” includes both copolymers in which (i) all named monomers are present as a block, or (ii) any subset of the named monomers are present as a block with the remaining monomers being randomly arranged, or (iii) all named monomers are randomly arranged.

The term “polystyrene” as used herein refers to film grade homopolymers and copolymers of styrene and its analogs and homologs, including -methyl-styrene and ring-substituted styrenes, such as for instance ring-methylated styrenes. The term “polystyrene polymer” is used to identify single polymers or blends of different polystyrene polymers as indicated above.

Particularly preferred polystyrene resins are Styrolux 684D by BASF and Polystyrol 143E by BASF or “K resin KR53” by “Chevron Phillips Chemicals” which can be used either alone or in blend.

The outer skin layer d) may advantageously comprise antiblock and/or slip additives as known in the art and as described for the sealing layer a). The total amount of these additives can typically range from 0.01-2.0 wt %, preferably from 0.02-1.0 wt %, even more preferably from 0.03-0.5 wt % in respect to the weight of the sealing layer a). Suitable antiblock additives and slip additives are those described above for the sealing layer a).

The thickness of the outer skin layer may be from 1 to 25 microns, preferably from 2 to 22 microns, more preferably from 4 to 20 microns, even more preferably from 5 to 18 microns.

The thickness of the outer skin layer, expressed as relative percentage vs. the thickness of the whole film can range from 2 to 25%, preferably from 3% to 20%, more preferably 4 to 15%, even more preferably from 5 to 12%.

The multilayer film of the invention may comprise one or more further layers.

The multilayer film of the present invention may comprise at least one polyamide layer e), preferably adhered to the barrier layer c) or two layers e) preferably adhered to the opposite surfaces of the barrier layer c). Said at least one or, preferably, two layer(s) e), are preferably directly adhered to the barrier layer c).

Said polyamide layer e) mainly comprises crystalline polyamides, generally in amount higher than 60% by weight of said layer composition, preferably higher than 80%, more preferably higher than 90%, even more preferably higher than 95%. Most preferably said polyamide layer e) consists of crystalline polyamides only.

With crystalline polyamides, a single crystalline polyamide or a blend or two or more crystalline polyamides is to be intended, preferably a single crystalline polyamide is intended.

The balance to 100% by weight of the composition of layer e) may be represented by suitable blendable thermoplastic materials or additives, such as for example ionomer-nylon alloy produced by Du Pont and commercialized under the tradename of Surlyn AM7927, provided that amorphous polyamides are not included.

Crystalline polyamides are those polyamides whose melting point is preferably within the range from about 130 to 230° C., more preferably from about 160 to 220° C., even more preferably from about 185 to 210° C.

Crystalline polyamides comprise crystalline homo-polyamides and co- (or ter-) polyamides, preferably selected among PA6; PA6.6; PA6.66; PA66.6; PA6.12; PA6.66.12; PA12; PA11; PA6.9; PA6.69; PA6.10; PA10.10; PA66.610; PA MXD6/MXDI, more preferably selected among PA6; PA6.66; PA66.6; PA6.12; PA6.66.12; PA12; PA11; PA6.9; PA MXD6/MXDI, even more preferably among PA6; PA6.66; PA6.12; PA6.66.12; PA12; PA11, most preferably being said crystalline polyamide PA6.66, and blends thereof.

Crystalline polyamides are preferably selected within the polyamides listed above, more preferably within those polyamides listed above having melting points falling within the range preferably from about 140 to 230° C., more preferably from about 160 to 220° C., even more preferably from about 185 to 210° C.

The thickness of said at least one polyamide layer e) is generally between 2 and 14 microns, preferably between 3 and 10 microns, even more preferably between 4 and 6 microns.

In the embodiment comprising two polyamide layers e) directly adhered to the opposite surfaces of the barrier layer c) the thickness of each layer is generally between 1 and 7 microns, preferably between 1.5 and 6 microns, even more preferably between 2 and 5 microns.

One or more inner “bulk” layer(s) or “structural” layer(s) f) can be advantageously present in the multilayer film of the present invention.

These layers generally comprise polymers used to improve the abuse or puncture resistance of the film or just to provide the desired thickness.

However, in VSP applications, these layers are also important to impart the required formability.

Polymers suitable for these layers are typically ethylene homo- and co-polymers, e.g. low density polyethylene (LDPE), ethylene-vinyl acetate copolymers (EVA), linear low density polyethylenes (LLDPE), linear very low density polyethylenes (VLDPE), ionomers, and blends thereof, preferably are ionomers and ethylene-vinyl acetate copolymers.

Preferred ethylene-vinyl acetate copolymer resins are ELVAX 3170 by Dow and ESCORENE ULTRA FL00119, by ExxonMobil.

Preferred ionomers include Surlyn 1601 and Surlyn 1650 by Dow.

A preferred LDPE resin is LD158BW by ExxonMobil.

Generally, in the films of the present invention at least one bulk layer f) is positioned between the outer sealing layer a) and the barrier layer c). Preferably, such at least one bulk layer f) positioned between the outer sealing layer a) and the barrier layer c) comprises one or more ionomers.

Preferably, the films of the present invention comprise two bulk layers f) positioned on the opposite sides with respect to the barrier layer c), but not necessarily in contact with said layer c). Optionally, such bulk layers comprise the same polymers, more preferably ethylene-vinyl acetate copolymers or ionomers.

In one embodiment, the two bulk layers f) positioned on the opposite sides with respect to the barrier layer c), not necessarily in contact with said layer c), comprise a major proportion, preferably an amount higher than 70 wt %, higher than 80 wt %, higher than 90 wt %, higher than 95 wt % with respect to the total layer f) weight, of ionomers.

In another embodiment, the two bulk layers f) positioned on the opposite sides with respect to the barrier layer c), not necessarily in contact with said layer c), comprise a major proportion, preferably an amount higher than 70 wt %, higher than 80 wt %, higher than 90 wt %, higher than 95 wt % with respect to the total layer f) weight, of ethylene-vinyl acetate copolymers.

In another embodiment, one of the two bulk layers f) positioned on the opposite sides with respect to the barrier layer c), not necessarily in contact with said layer c), comprises a major proportion, preferably an amount higher than 70 wt %, higher than 80 wt %, higher than 90 wt %, higher than 95 wt % with respect to the total layer f) weight, of ethylene-vinyl acetate copolymers, the other one comprises a major proportion, preferably an amount higher than 70 wt %, higher than 80 wt %, higher than 90 wt %, higher than 95 wt % with respect to the total layer f) weight, of ionomers. Preferably, in this embodiment, the bulk layer f) comprising ionomers is between the barrier layer c) and the sealant layer a).

The films of the invention may also comprise more than two bulk layers f), for example three bulk layers f), one of which is between the barrier layer c) and the sealant layer a), and two of which are between the barrier layer c) and the outer skin layer d).

The total thickness of the bulk layer(s) f) present in the overall structure will depend mainly on the overall thickness desired for the film. Said thickness, expressed as a percentage in respect of the total thickness of the present film, generally ranges between 30% and 80%, preferably between 40% and 75%, more preferably between 50% and 70%.

The resin(s) of the bulk layer(s) can be advantageously present in the film of the present invention in an amount of at least 25 wt %, preferably at least 40 wt %, even more preferably at least 60 wt %, based on the total weight of the film.

Other layers that may be optionally present in the multilayer film of the invention are “tie” or “adhesive” layers g) that are employed to better adhere one layer to another in the overall structure.

In particular the film may include tie layer(s) g) directly adhered to one or both sides of the internal barrier layer c) and/or to one or both sides of polyamide layer(s) e) to better adhere said barrier layer c) or said polyamide layer(s) e) to the adjacent bulk layer(s) f). Additional tie layers may also be used to better adhere the bulk layer(s) f) to the adjacent inner layer b) and/or to the outer skin layer d).

The composition of the sealant layer a) and of the outer skin layer d) can be adjusted by those skilled in the art such that a tie layer g) does not need to be present in direct contact with layers a) and d). In such a case, the basic structure of the film of the present invention can be referred to as sequence a/b/c/d.

Tie layers g) may include polymers having grafted polar groups so that the polymer is capable of covalently bonding to polar polymers such as EVOH or polyamides. Useful polymers for tie layers g) include ethylene-unsaturated acid copolymers, ethylene-unsaturated ester copolymers, anhydride-modified polyolefins, polyurethane, and mixtures thereof. Preferred polymers for tie layers g) include one or more of thermoplastic polymers such as ethylene-vinyl acetate copolymers with high vinyl acetate content (e.g. 18-28 wt % or even more), ethylene-(meth)acrylic acid copolymers, ethylene homo-polymers or co-polymers, modified with anhydride or carboxylic acid functionalities, blends of these resins or blends of any of the above resins with an ethylene homo- or co-polymer, and the like known resins.

Commercial tie resins particularly suitable for EVOH layer are OREVAC 18303 and OREVAC 18300 by SK Chemicals and BYNEL 4125 by Dow. Another example of particularly suitable tie resin is BYNEL 46E1060 by Dow.

Tie layers g) are of a sufficient thickness to provide the adherence function, as is known in the art. Their thickness is generally comprised between 2 and 20 microns, preferably between 3 and 13 microns.

One or more of any of the layers of the multilayer film of the present invention may include appropriate amounts of additives typically included in structures for food packaging for the desired effect, as it is known to those of skill in the packaging films art. For example, a layer may include additives such as slip agents, antiblock agents, antioxidants, fillers, dyes and pigments, cross-linking enhancers, cross-linking inhibitors, radiation stabilizers, oxygen scavengers, antistatic agents, and the like agents.

Generally, the layers sequence of the films of the present invention can be selected among the following non exhaustive list:
a/b/c/d, a/b/f/c/d, a/b/f/c/f/d, a/b/f/c/f/f/d, a/b/f/f/c/f/f/d, a/b/f/g/c/d, a/b/f/g/c/f/d, a/b/f/g/c/f/f/d, a/b/f/f/g/c/f/f/d, a/b/f/g/c/g/d, a/b/f/g/c/g/f/d, a/b/f/g/c/g/f/f/d, a/b/f/f/g/c/g/f/f/d, a/b/f/c/g/d, a/b/f/c/g/f/d, a/b/f/c/g/f/f/d, a/b/f/f/c/g/f/f/d, a/b/e/c/e/d, a/b/f/e/c/e/d, a/b/f/e/c/e/f/d, a/b/f/f/e/c/e/f/d, a/b/f/e/c/e/f/f/d, a/b/f/f/e/c/e/f/f/d, a/b/g/e/c/e/d, a/b/g/e/c/e/g/d, a/b/e/c/e/g/d, a/b/f/g/e/c/e/g/f/d, a/b/f/e/c/e/g/f/d, a/b/f/g/e/c/e/f/d, a/b/f/f/g/e/c/e/g/f/d, a/b/f/g/e/c/e/g/f/f/d, a/b/f/f/e/c/e/g/f/d, a/b/f/e/c/e/g/f/f/d, a/b/f/f/g/e/c/e/f/f/d, a/b/f/b/c/f/d, a/b/f/b/c/b/f/f/d, a/b/f/c/b/f/d.

Where the multilayer film representation above includes the same letter more than once, each occurrence of the letter may represent the same composition or a different composition within the class that performs a similar function.

For use as VSP top web, the film according to the first object of the present invention is characterized by a thickness preferably lower than 180 microns, more preferably lower than 150 microns, even more preferably lower than 130 microns, still more preferably lower than 110 microns, 100 microns, 90 microns, 80 microns or 70 microns. For example, for such use the thickness may be from about 25 to about 180 microns, preferably from about 30 to about 150 microns.

In particular, for VSP top webs, thicker films will be used for packaging products of higher profile while thinner film are sufficient and preferred in order to vacuum skin package products with a shallow profile. In particular, thicker films i.e. 100 microns or more, are suitable for demanding applications like packaging of high-profile products and/or with irregular and sharp surfaces, such as bone-in meat or frozen products or crabs and the like.

For use as VSP bottom web, the film according to the first object of the present invention may have a thickness generally higher than 180 microns, for example comprised between 180 microns and 500 microns, preferably between 250 and 400 microns.

The films of the present invention are advantageous with respect to current VSP films on the market, providing comparable or even higher barrier performances in terms of oxygen transmission rate (OTR) with a lower thickness of the EVOH barrier layer.

The films of the present invention may include any number of layers from 4 to 13, from 5 to 12, preferably from 6 to 11 layers and more preferably from 7 to 10 layers.

Preferably, the films of the present invention have at least 4, at least 5, at least 6, at least 7 layers.

The films of the present invention can be either cross-linked or not cross-linked. When they are used as top webs in VSP, they are preferably cross-linked.

As used herein, the term cross-linked means that at least a part of the present film is cross-linked. Preferably, all the layers of the present film are cross-linked.

Cross-linking may be imparted chemically or physically as described herein after.

The films according to the present invention are not heat-shrinkable as herein defined. In particular, the films according to the present invention have an unrestrained linear thermal shrinkage (free heat-shrinkage) at 160° C. (measured in oil) in both the machine and transverse directions of less than 15%, preferably less than 10%, more preferably lower than 5% as measured according to ASTM D-2732 Test Method, which is incorporated herein by reference in its entirety.

The film according to the present invention has a good formability and, when used as a top web in vacuum skin packages, results in the formation of little webbing and bridging, evaluated by the test method provided herein (Experimental part).

Finally, the films according to the present invention can be printed by common method known in the art.

The films according to the present invention are not oriented.

A second object of the present invention is a vacuum skin package comprising a bottom support, a product loaded onto said support and a top film draped over the product and sealed over the entire surface of the support not covered by the product, wherein at least one of the support and/or the top film is a film according to the first object of the present invention. Preferably, it is an object of the present invention a vacuum skin package comprising a support, a product loaded onto said support and a top film according to the first object of the present invention.

The support may be flat or hollow, e.g. tray-shaped. Any support generally suitable for VSP applications may be used within the package of the present invention. If shaped, the support may be thermoformed in-line or may be an off-line pre-made tray.

The support is typically a rigid, semi-rigid material or in alternative a flexible material.

The support may comprise a bottom web made of a plastic web, optionally adhered or laminated to a non-plastic material.

The support can be a mono- or a multilayer material.

In case of a monolayer support, it may be made for instance of polypropylenes, polyesters, poly(vinyl chloride) (PVC) or HDPE.

Preferably, the support is made of a multilayer material comprising an outer heat-sealable layer to allow sealing of the top film to the part of the support not covered by the product, and at least one bulk layer to provide good mechanical properties.

Preferably, the seal layer comprises one or more of the polymers previously listed for the heat sealing layer a) of the films of the present invention, such as polyolefins, like ethylene homo- or co-polymers, ethylene/vinyl acetate copolymers, ethylene-acrylic acid copolymers, ethylene-alkyl acrylate copolymers, ethylene-methacrylic acid copolymers, ethylene-alkyl methacrylate copolymers, ethylene-alkyl acrylate-maleic anhydride copolymers, ionomers, polyesters.

Suitable sealing layers may also include peelable blends (also named frangible blends, which are blends of immiscible polymers known in the art of packaging) to provide the package with an easy-to-open feature.

The bulk layer of the support may comprise one or more polymers such as polyethylene, polystyrene, polyester, poly(vinyl chloride) (PVC), polypropylene, polyamides, polylactic acid derivatives.

In a number of applications, the support is also required to have gas barrier properties, in particular oxygen barrier properties. Thus, in addition to a sealing layer and at least a bulk layer, the support may be provided with a gas barrier layer.

Suitable thermoplastic materials with low oxygen transmission characteristics to provide packaging materials with gas barrier properties are PVDC, EVOH, polyamides, polyesters or blends thereof.

Additional layers, such as tie layers, to better adhere the gas barrier layer to the adjacent layers, may be present in the bottom web material for the support and are preferably present depending in particular on the specific resins used for the gas barrier layer.

In case of a multilayer structure, part of it can be foamed and part can be un-foamed. For instance, the support may comprise (from the outermost layer to the innermost food-contact layer) one or more structural layers—typically of a material such as polystyrene, polyester, poly(vinyl chloride), polyethylene, polypropylene, polyamide, paper or cardboard; a gas barrier layer and a sealing layer.

In other embodiments, the support can be made of cardboard or of an aluminum foil on which a thermoplastic liner film is laminated or coated. The surface of the liner film which will contact the product and form the seal with the top film may comprise one or more of the polymers previously listed for the outer heat sealing layer a) of the film of the invention, such as polyolefins, like ethylene homo- or co-polymers, ethylene/vinyl acetate copolymers, ethylene-acrylic acid copolymers, ethylene-alkyl acrylate copolymers, ethylene-methacrylic acid copolymers, ethylene-alkyl methacrylate copolymers, ethylene-alkyl acrylate-maleic anhydride copolymers, ionomers, polyesters.

The supports to be used in combination to the film according to the first object of the present invention can be pigmented.

The overall thickness of the support will typically be up to 8 mm, preferably it will be comprised between 0.1 and 7 mm and more preferably between 0.2 and 6 mm. Preferably, flexible bottom webs may have a thickness of from 80 to 400 microns.

In one embodiment, the support may include at least one hole, in particular a pre-made or an in-line-made hole. The at least one hole advantageously allows vacuuming the package more rapidly and efficiently, as detailed for instance in WO2014060507A1, WO2011/012652 and WO2014/060507 in the name of the Applicant.

In an embodiment, the support can be a bottom web according to the first object of the present invention. In such embodiment, the top film of the vacuum skin package may be any commercially available multilayer film suitable as top web. Advantageously, however, also the top film can be a film according to the first object of the present invention, such that a package with both the top and the bottom webs according to the present invention is provided, with further improved oxygen barrier properties and, extended shelf life of the packaged product.

The VSP package of the present invention comprises a product, preferably a food product. Food products that can be advantageously packaged by using the films according to the first object of the present invention are, in a no limiting list, fish, meat, particularly fresh red meat, poultry, cheese, ready-meals, processed meat. Food products which are particularly sensitive to oxygen mediated spoilage and for which a long shelf life is desired, such as meat, and in particular fresh red meat, particularly benefit of the low oxygen transmission rate performance of the VSP packages of the present invention.

In an embodiment, the VSP packages of the present invention are microwaveable as previously defined. In case of microwave applications, rigid or semi-rigid supports comprising a polymer with a relatively high melting point such as polypropylene, polystyrene, polyamide, 1,4-polymethylpentene or crystallized polyethylene terephthalate (CPET) are preferred.

Solid polypropylene is particularly preferred because of its strength, its ability to support a food product, and its relatively high melting point. Other materials will be more or less desirable for microwave applications depending on their physical characteristics such as those described above.

A third object of the present invention is a vacuum skin packaging process for manufacturing a VSP package according to the second object of the present invention, in which at least one of the bottom support and/or the top film is a film according to the first object of the present invention. Preferably, it is an object of the present invention a vacuum skin packaging process for manufacturing a VSP package in which the top film is a film according to the first object of the present invention.

The VSP process comprises the steps of
providing a bottom support, optionally a bottom film according to the present invention,
disposing a product onto the support,
providing a top film comprising an outer sealing layer, optionally a film according to the first object of the present invention, in which the outer sealing layer of the top film faces the support, wherein at least one of the support and/or the top film is a film according to the first object of the present invention,
heating the top film and moulding it down upon and around the product and against the support, the space between the heated top film and the support having been evacuated to form a tight skin around the product, and
tight sealing the top film to the entire surface of the support not covered by the product by differential air pressure.

In more detail, the skin-forming, top film is fed to the upper section of a heated vacuum chamber comprising an upper and a lower section, and a vacuum is applied thereto from the outside, thereby drawing the top film into a concave form against the inwardly sloping walls of the upper section of the chamber and against the ports contained in the horizontal wall portion thereof (the top of the dome). Any conventional vacuum pump can be used to apply the vacuum and, preferably, the top film is suitably pre-heated prior to the foregoing operation to render it more formable and thus better able to assume a concave shape in the upper section of the vacuum chamber.

Preferably, with the vacuum packaging machines called “Rollstock”, which shape in-line the bottom support at an initial station of the machine itself, pre-heating of the films of the present invention is performed at temperatures lower than 140° C., than 130° C., than 120° C., or even lower.

The product to be packaged is positioned on a support that can be flat or shaped, typically tray-shaped, and placed on a platform that is carried in the lower section of the vacuum chamber, just below the dome. The support can be shaped off-line or, alternatively, in-line at an initial thermoforming station on the vacuum packaging machine. In an embodiment, the support can be a bottom film according to the first object of the present invention. Then the vacuum chamber is closed by moving the upper section down onto the lower one and during this whole sequence of operations vacuum is constantly applied to retain the concave shape of the film. Once the vacuum chamber is closed, vacuum is applied also in the lower section of the vacuum chamber in order to evacuate the space between the support and the top skin-forming film. Vacuum in the upper section of the vacuum chamber continues to be applied to retain the concave shape of the skin-forming film until the area between the support and the skin-forming film is evacuated, then it is released and atmospheric pressure is admitted. This will collapse the softened top skin-forming film over the product and the support, as the atmosphere pushing the skin-forming film from the top and the vacuum pulling it from the bottom will cooperatively work to have the skin-forming film substantially conform to the shape of the product to be packaged on the support. Optionally, after the evacuation step has been completed, a suitably selected purging gas or gas mixture could be flushed over the product to generate a very low residual gas pressure into the package. In some rare instances heat-sealing bars or other sealing means can be present in the vacuum chamber to carry out a perimeter heat-seal of the skin-forming film to the support member.

The VSP packages of the present invention may be manufactured according to any known VSP process.

As mentioned, the support can be shaped off-line (i.e. preformed) and in such a case the VSP machine used is referred to as a “Tray Skin” machine or, alternatively, the support can be shaped in-line at an initial station on the “Rollstock” vacuum packaging machine.

Preferred machines for performing the packaging process according to the third object of the present invention are supplied by Multivac, Mondini, Sealpac and Ulma.

A recently developed skin packaging process is described in WO2009141214, EP2722279, EP2459448. In such process, the support to be used for the vacuum skin process is perforated in order to get a more efficient vacuum. Such process can be performed by using, for example, machine TRAVE E340, Trave 1000 Darfresh or Trave 590XL Darfresh by Mondini. Herein, this peculiar VSP process on perforated trays is also named “Darfresh On Tray”.

During the vacuum skin packaging cycle the dome temperature may be set up to a temperature generally comprised between 140° C. and 240° C., preferably between 160° C. and 220° C., typically between 180° C. and 210° C.

A fourth object of the present invention is the use of a film according to the first object of the present invention for vacuum skin packaging applications.

In an embodiment, the film according to the first object is used as a top film for VSP applications. In this embodiment, the film is characterized by a thickness generally lower than 180 microns, preferably lower than 150 microns, more preferably lower than 130 microns, even more preferably lower than 110 microns.

When used as top film, the film of the invention is preferably used in combination with a support having a sealing layer comprising one or more polymers selected from polyolefins, such as ethylene homo- or co-polymers, ethylene/vinyl acetate copolymers, ethylene-acrylic acid copolymers, ethylene-alkyl acrylate copolymers, ethylene-methacrylic acid copolymers, ethylene-alkyl methacrylate copolymers, ethylene-alkyl acrylate-maleic anhydride copolymers, ionomers and polyesters.

The support to which the top film according to the first object of the invention is sealed can be rigid, semi-rigid or flexible, and can be flat or shaped (typically tray-shaped). Shaped support can be thermoformed either off-line (preformed trays) or in-line at an initial station during the vacuum packaging process.

In another embodiment, the film according to the first object is used as a bottom support for VSP applications. In this embodiment, the film is characterized by a thickness generally higher than 180 microns, for example comprised between 180 microns and 500 microns, preferably between 250 and 400 microns.

When used as bottom support, the film of the invention can be used in combination with any available top film suitable for VSP application. Preferably, also the top film is a film according to the invention.

The films of the present invention can be manufactured by any suitable co-extrusion process, either through a flat or a round extrusion die, preferably by round cast or by hot blown extrusion techniques. Suitable round or flat coextrusion lines for coextruding the films of the invention are well known in the art. An exemplary manufacturing process is the one described in U.S. Pat. No. 4,287,151 that involves coextrusion through a round extrusion die.

The films of the present invention may be either crosslinked or not crosslinked. Crosslinked films are preferred when they are used as top films in VSP applications. Crosslinking may occur by any chemical or low or high radiation method or combination thereof.

The preferred method of crosslinking is by electron-beam irradiation, which is well known in the art. One skilled in the art can readily determine the radiation exposure level suitable for a particular application. Generally, however, radiation dosages of up to about 250 kGy are applied, typically between about 80 and about 240 kGy, with a preferred dosage of between 90 and 230 kGy.

Irradiation is carried out conveniently at room temperature, although higher and lower temperatures, for example, from 0° C. to 60° C. may be employed.

The manufacturing process of the present films does not include any orientation step.

### EXPERIMENTAL PART

### EXAMPLES

The following examples are presented for the purpose of further illustrating and explaining the present invention and are not to be taken as limiting in any regard. Unless otherwise indicated, all parts and percentages are by weight.

All the films of the examples and of comparative examples were manufactured via round cast coextrusion followed by quenching with cold water at 15° C. The films were then cross-linked by electron-beam irradiation at 130 KGys and wound on rolls.

Table 1 reports the polymers used for manufacturing the films of the invention and the comparative films.

TABLE 1
Polymers

| Tradename | Supplier | Acronym |
|---|---|---|
| LD259 | ExxonMobil | LDPE1 |
| RIGIDEX HD6070FA | INEOS Olefins & polymers | HDPE1 |
| | Europe | |
| Surlyn 1601 | DOW | ION1 |
| OREVAC 18300 | SK Chemicals | LLDPE-md1 |
| EVAL F101B | EVALCA/Kuraray | EVOH1 |
| ESCORENE ULTRA | ExxonMobil | EVA1 |
| FL00119 | | |
| Lumicene MPE M 6040 | Total Petrochemicals | HDPE2 |
| BYNEL 40E1053 | DOW | HDPE-md1 |
| POLYBATCH FSU 105E | LyondellBasell Industries | LDPE2 |
| EV3851V | Chang Chun Petrochemicals | EVOH2 |
| | Ltd. (CCP) | |
| ELVAX 3170 | DOW | EVA2 |
| Surlyn 1702 | DOW | ION2 |
| CONPOL 20S2 | DOW | EMAA1 |
| LD158BW | ExxonMobil | LDPE3 |
| CONSTAB AB 06051 LD | IMCD Italia | LLDPE1 |
| ESCORENE ULTRA FL | ExxonMobil | EVA3 |
| 00728CC | | |

LDPE1: Low Density Polyethylene Homopolymer; Density 0.915 g/cc; Melt Flow Rate (190° C./2.16 kg) 12 g/10 min; Melting point 105° C.;
HDPE1: Polyethylene High Density Copolymer; Density 0.960 g/cc; Melt Flow Rate (190° C./2.16 kg) 7.6 g/10 min; Melting point 132° C.;
ION1: Sodium Neutralized Ethylene Methacrylic Acid Copolymer; Density 0.940 g/cc; Melt Flow Rate (190° C./2.16 kg) 1.30 g/10 min; Melting point 96° C.;
LLDPE-md1: Linear Low Density Maleic Anhydride-Modified Polyethylene; Density 0.916 g/cc; Melt Flow Rate (190° C./2.16 kg) 2.3 g/10 min; Melting point 120° C.; Vicat softening point 85° C.;
EVOH1: Hydrolyzed Ethylene/Vinyl Acetate Copolymer; Comonomer content (Ethylene) 32%; Density 1.196 g/cc; Melt Flow Rate (190° C./2.16 kg) 1.6 g/10 min; Melting point 183° C.; Vicat softening point 173° C.;
EVA1: Ethylene/Vinyl Acetate Copolymer; Comonomer content (Vinyl Acetate) 19%; Density 0.942 g/cc; Melt Flow Rate (190° C./2.16 kg) 0.650 g/10 min; Melting point 85° C.; Vicat softening point 62° C.;
HDPE2: Polyethylene High Density Homopolymer; Density 0.96 g/cc; Melt Flow Rate (190° C./2.16 kg) 4 g/10 min; Melting Point 134° C.; Vicat softening point 132° C.;
HDPE-md1: Maleic Anhydride-Modified High Density Polyethylene; Density (23° C.) 0.958 g/cc; Melt Flow Rate (190° C./2.16 kg) 2.00 g/10 min; Melting point 130° C.; Vicat softening point 129° C.;
LDPE2: Low Density Polyethylene with antiblock/slip - SiO2 10%; Density 0.98 g/cc; Melt Flow Rate (190° C./2.16 kg) 20 g/10 min;
EVOH2: Hydrolyzed Ethylene/Vinyl Acetate Copolymer; Comonomer content (Ethylene) 38%; Crystallization point 151° C.; Density (23° C.) 1.167 g/cc; Glass Transition 54° C.; Melt Flow Rate (190° C./2.16 kg) 1.80 g/10 min; Melt Flow Rate (210° C., 2.16 kg) 3.70 g/10 min; Melting point 173° C.;
EVA2: Ethylene/Vinyl Acetate Copolymer; Comonomer content (Vinyl Acetate) 18%; Density 0.94 g/cc; Melt Flow Rate (190° C./2.16 kg) 2.5 g/10 min; Melting point 90° C.;
ION2: Zinc Neutralized Ethylene Methacrylic Acid Copolymer; Density 0.940 g/cc; Melt Flow Rate (190° C./2.16 kg) 14 g/10 min; Melting point 93° C.;
EMAA1: Ethylene/Methacrylic Acid Copolymer with 20% slip additive (amide wax); Density 0.940 g/cc; Melt Flow Rate (190° C./2.16 kg) 55 g/10 min; Melting point 95° C.;
LDPE3: Low Density Polyethylene Homopolymer; Density 0.925 g/cc; Melt Flow Rate (190° C./2.16 kg) 2 g/10 min; Melting point: 111° C.;
LLDPE1: Low Density Polyethylene with antiblock/slip (silica); Density 1.03 g/cc; Melt Flow Rate (190° C./2.16 kg) 3.3 g/10 min;
EVA3: Ethylene/Vinyl Acetate Copolymer; Comonomer content (Vinyl Acetate) 27.50%; Density 0.951 g/cc; Melt Flow Rate (190° C./2.16 kg) 7 g/10 min; Melting point 73° C.

Table 2 reports the layers compositions for the films of the invention (examples).

TABLE 2
films of the invention

| | | | Layer Thickness | Film Thickness |
|---|---|---|---|---|
| Film | Layer | Layer Composition | (microns) | (microns) |
| 1 | 1 | 100% LDPE1 | 16 | 135.5 |
| | 2 | 100% HDPE1 | 9 | |
| | 3 | 100% ION1 | 31 | |
| | 4 | 100% LLDPE-md1 | 3 | |
| | 5 | 100% EVOH1 | 6 | |
| | 6 | 100% LLDPE-md1 | 3 | |
| | 7 | 100% EVA1 | 27.5 | |
| | 8 | 100% ION1 | 25 | |
| | 9 | 100% LDPE1 | 15 | |
| 2 | 1 | 90% EVA3 | 7 | 100 |
| | | 10% LLDPE1 | | |
| | 2 | 100% EVA1 | 26 | |
| | 3 | 100% HDPE1 | 10 | |
| | 4 | 100% LLDPE-md1 | 5 | |
| | 5 | 100% EVOH2 | 7 | |
| | 6 | 100% LLDPE-md1 | 5 | |
| | 7 | 100% EVA1 | 26 | |
| | 8 | 100% EVA1 | 12 | |
| | 9 | 95% HDPE2 | 2 | |
| | | 5% LLDPE1 | | |
| 3 | 1 | 100% LDPE1 | 13 | 138.5 |
| | 2 | 100% HDPE1 | 9 | |
| | 3 | 100% EVA1 | 33 | |
| | 4 | 100% LLDPE-md1 | 3 | |
| | 5 | 100% EVOH1 | 6.5 | |
| | 6 | 100% LLDPE-md1 | 3 | |
| | 7 | 100% EVA1 | 25 | |
| | 8 | 100% EVA1 | 36 | |
| | 9 | 98% LDPE1 | 10 | |
| | | 2% LDPE2 | | |
| 4 | 1 | 100% LDPE1 | 9 | 102.50 |
| | 2 | 100% HDPE1 | 9 | |
| | 3 | 100% EVA1 | 22.5 | |
| | 4 | 100% LLDPE-md1 | 3 | |
| | 5 | 100% EVOH1 | 6.5 | |
| | 6 | 100% LLDPE-md1 | 3 | |
| | 7 | 100% EVA1 | 17 | |
| | 8 | 100% EVA1 | 22.5 | |
| | 9 | 98% LDPE1 | 10 | |
| | | 2% LDPE2 | | |
| 5 | 1 | 100% LDPE1 | 16 | 140 |
| | 2 | 100% HDPE1 | 9 | |
| | 3 | 100% ION1 | 37 | |
| | 4 | 100% LLDPE-md1 | 3 | |
| | 5 | 100% EVOH1 | 6.5 | |
| | 6 | 100% LLDPE-md1 | 3 | |
| | 7 | 100% EVA1 | 27.5 | |
| | 8 | 100% ION1 | 23 | |
| | 9 | 95% LDPE1 | 15 | |
| | | 5% LDPE2 | | |
| 6 | 1 | 100% LDPE1 | 16 | 140 |
| | 2 | 100% HDPE1 | 9 | |
| | 3 | 100% ION1 | 37 | |
| | 4 | 100% LLDPE-md1 | 3 | |
| | 5 | 100% EVOH2 | 6.5 | |
| | 6 | 100% LLDPE-md1 | 3 | |
| | 7 | 100% EVA1 | 27.5 | |
| | 8 | 100% ION1 | 23 | |
| | 9 | 95% LDPE1 | 15 | |
| | | 5% LDPE2 | | |
| 7 | 1 | 100% LDPE1 | 13 | 140 |
| | 2 | 100% HDPE1 | 15 | |
| | 3 | 100% EVA1 | 33 | |
| | 4 | 100% LLDPE-md1 | 3 | |
| | 5 | 100% EVOH2 | 6.5 | |
| | 6 | 100% LLDPE-md1 | 3 | |
| | 7 | 100% EVA1 | 25.5 | |
| | 8 | 100% EVA1 | 36 | |
| | 9 | 100% HDPE1 | 5 | |

Table 3 reports the layers compositions for the comparative films (comparative examples).

TABLE 3
comparative films

| | | | Layer Thickness | Film Thickness |
|---|---|---|---|---|
| Film | Layer | Layer Composition | (microns) | (microns) |
| C1 | 1 | 100% LDPE1 | 13 | 150 |
| | 2 | 100% EVA2 | 8 | |
| | 3 | 100% EVA1 | 38 | |
| | 4 | 100% LLDPE-md1 | 3 | |
| | 5 | 100% EVOH1 | 8 | |
| | 6 | 100% LLDPE-md1 | 3 | |
| | 7 | 100% EVA1 | 29 | |
| | 8 | 100% EVA1 | 30 | |
| | 9 | 100% HDPE1 | 18 | |
| C2 | 1 | 98% ION2 | 6 | 100 |
| | | 2% EMAA1 | | |
| | 2 | 100% LDPE3 | 14 | |
| | 3 | 100% EVA1 | 19 | |
| | 4 | 100% LLDPE-md1 | 3 | |
| | 5 | 100% EVOH1 | 8 | |
| | 6 | 100% LLDPE-md1 | 3 | |
| | 7 | 100% EVA1 | 11 | |
| | 8 | 100% LDPE3 | 26 | |
| | 9 | 100% HDPE1 | 10 | |
| C3 | 1 | 100% LDPE1 | 16 | 140 |
| | 2 | 100% ION1 | 18.5 | |
| | 3 | 100% EVA1 | 34 | |
| | 4 | 100% LLDPE-md1 | 3 | |
| | 5 | 100% EVOH2 | 13 | |
| | 6 | 100% LLDPE-md1 | 3 | |
| | 7 | 100% EVA1 | 20 | |
| | 8 | 100% ION1 | 22.5 | |
| | 9 | 100% HDPE1 | 10 | |
| C4 | 1 | 100% LDPE1 | 13 | 140 |
| | 2 | 100% HDPE1 | 8 | |
| | 3 | 100% EVA1 | 34 | |
| | 4 | 80% HDPE2 | 3 | |
| | | 20% HDPE-md1 | | |
| | 5 | 100% EVOH1 | 6.5 | |
| | 6 | 80% HDPE2 | 3 | |
| | | 20% HDPE-md1 | | |
| | 7 | 100% EVA1 | 25 | |
| | 8 | 100% EVA1 | 37.5 | |
| | 9 | 98% LDPE1 | 10 | |
| | | 2% LDPE2 | | |

### Water Vapor Transmission Rate (WVTR) of the Resins of the Films

The WVTR values of the resins of the relevant layers of the films of the invention and of comparative films C1-C3 are reported in Table 4, expressed in g/sqm·day. The WVTR was measured with a Mocon Permatran W 700 instrument according to ASTM F-1249 at 38° C. and 90% RH, on a flat cast extruded monolayer sample having a thickness of 50 microns.

TABLE 4

| Resin | WVTR (g/sqm · day) |
|---|---|
| LDPE1 | 10 |
| HDPE1 | 3.96 |
| ION1 | 16 |
| EVA1 | 101 |
| HDPE2 | 4.51 |
| EVA2 | 101 |
| LDPE3 | 9.4 |

### Packaging Evaluation: Formability Test

The formability test evaluates the ability of a VSP top film to be formed over a product by measuring the incidence of sealing defects, i.e. bridging and webbing pleats.

Vacuum skin packages were manufactured with a conventional vacuum skin cycle using a Rollstock machine (R570CD by Multivac), with a dome height of 100 mm heated at 210° C., vacuum time 1 s. The top webs were the films of Examples 1-7 according to the invention and the film of comparative examples C1 and C2 and the bottom web (supplied to the machine in the form of a roll, to be thermoformed on the machine before the sealing cycle) was a 350 microns polyester-based web with an EVA sealant layer. The bottom forming depth was 5 mm and the bottom dimensions were 250 mm×135 mm.

The packaged products were parallelepiped (95 mm wide×180 mm long×45 mm high) and circular (diameter 105 mm, height 28 mm) plastic blocks. The machine processed 3 packs per cycle, 5 cycles were repeated, therefore a total of 15 packs with parallelepiped blocks and 15 packs with circular blocks for each top film of the examples and comparative examples were manufactured. These packs were scored for formability by visually evaluating the pack aspect, the presence of webbing (pleats located in the corner) and bridging (pleats located on the surface). Visual evaluation was performed by two panelists.

The average results of this evaluation for the film of Ex. 1-7 and C1, C2 and C4 are reported in Table 5.

TABLE 5

| Top film | Formability |
|---|---|
| 1 | Very good |
| 2 | Very good |
| 3 | Very good |
| 4 | Very good |
| 5 | Good |
| 6 | Good |
| 7 | Very good |
| C1 | Very good |
| C2 | Very good |

As can be seen from Table 5, all the films of the invention proved to be highly formable in the VSP packaging cycle, with a performance comparable to that of the Comparative films C1 and C2, which are standard VSP top webs of reference. All the tested films of the invention provided for a good shaping of the film around the packaged material and good sealing properties.

### Oxygen Transmission Rate

The oxygen transmission rate (OTR) has been evaluated for the films of Example 1 and of Comparative Example 1 using a Mocon Ox-Tran 2/22 instrument in accordance with ASTM F-1927 in the following conditions:
23° C., 0% RH on both sides of the film
23° C., 90% RH on one side of the film (sealant layer, inner side of the resulting package (“in”)) and 70% RH on the other side of the film (skin layer, outer side of the resulting package (“out”)) to create a humidity gradient which mimics the real conditions in which the film is used in the final package.

The OTR values (average values calculated on two samples measurements, expressed as cc/sqm·day·atm) are reported in Table 6.

TABLE 6

| Top | OTR 23° C., 0% RH | OTR 23° C., 90% RH in, 70% RH out |
|---|---|---|
| film | (cc/sqm · day · atm) | (cc/sqm · day · atm) |
| 1 | 1.6 | 5 |
| C1 | 1.5 | 5.3 |

Both in dry conditions (0% RH) and in conditions of humidity gradient (90% RH in, 70% RH out) the OTR values of the film of Example 1 according to the invention and of the film of Comparative Example 1 are comparable, notwithstanding the thickness of the EVOH layer in the film of Example 1 is lower than the thickness of the EVOH layer in the film of C1 (6 microns and 8 microns, respectively). This result is particularly surprising for the test in the conditions of humidity gradient.

In general, the films according to the invention have an EVOH layer with a thickness comprised between 2 and 10 microns and typically show OTR values, measured in accordance with ASTM F-1927 at 23° C., 90% RH in, 70% RH out, in the range from 2 to 10 cc/sqm·day·atm, preferably from 3 to 8 cc/sqm·day·atm.

### Shelf Life

Preliminary shelf life tests were carried out with fresh red meat packaged using the films of the invention as top webs of VSP packages. All the packages proved capable of granting a comparable or even improved shelf life in respect to packages manufactured with the comparative films as top webs.

Another shelf life test was carried out at a customer's premises with fresh red meat, using the film of Example 2 as the top web of VSP packages and a commercially available 250 microns PET film as the bottom web.

About 100 packages were manufactured using a Rollstock skin packaging machine, kept in refrigerator at 2° C. for 3 weeks and visually checked daily. The packaged products were different cuts of fresh red meat.

After 3 weeks the packs were opened, and all products showed a satisfactory shelf life (no color changes or other signs of spoilage).

Shelf life tests were also carried out at a customer's premises with fish, using the film of Example 2 as the top web of VSP packages and a commercially available 250 microns PET film as the bottom web. Multivac R570CD machine was used to manufacture the packages.

50 packages were manufactured, kept in refrigerator at 2° C. for up to 8 days and visually checked daily. The packaged products were fish, of different types and sizes, whole and portioned.

After 8 days the packages were opened, and all products showed a satisfactory shelf life (no color changes or other signs of spoilage).

1. A coextruded, non-oriented, multilayer film suitable for use as top web in vacuum skin packaging (VSP) comprising at least:
an outer sealing layer a),
an inner barrier layer c) which comprises least 60% by weight with respect to the weight of layer c), of an ethylene vinyl alcohol (EVOH) copolymer,
at least one inner layer b) which comprises at least 70% by weight with respect to the weight of layer b) of one or more polymers having water vapor transmission rate (WVTR) not higher than 8 g/sqm·day, when measured according to ASTM F-1249 at 38° C. and 90% relative humidity (RH), on a flat cast extruded sample having a thickness of 50 microns, and
an outer skin layer d),
wherein:
said at least one inner layer b) is between the sealing layer a) and the barrier layer c);
no inner layers b) are present between the barrier layer c) and the outer skin layer d), and
the total thickness of the at least one inner layer b) between the sealing layer a) and the barrier layer c) is between 2% and 14% of the thickness of the whole film.

2. The film of claim 1 wherein the one or more polymers of the at least one inner layer b) having water vapor transmission rate (WVTR) not higher than 8 g/sqm·day, when measured according to ASTM F-1249 at 38° C. and 90% RH, on a flat cast extruded sample having a thickness of 50 microns are selected among high-density polyethylene (HDPE), cyclic olefin copolymers (COC), polypropylene (PP) and mixtures thereof, preferably such polymer is HDPE.

3. The film of claim 1 wherein the inner layer b) comprises an amount lower than 30% by weight with respect to the weight of layer b), of one or more polymers selected among ethylene homo- and co-polymers other than HDPE, preferably low density polyethylene, ethylene-vinyl acetate copolymers, linear low density polyethylenes, linear very low density polyethylenes and ionomers.

4. The film of claim 1 wherein the at least one inner layer b) is directly adhered to the sealing layer a).

5. The film of claim 1 wherein the thickness of the barrier layer c) ranges from 3% to 10% of the thickness of the whole film.

6. The film of claim 1 wherein the thickness of the barrier layer c) is comprised between 2 and 10 microns and/or wherein the OTR values of such film is in the range from 2 to 10 cc/sqm·day·atm, when measured in accordance with ASTM F-1927 at 23° C. in the following RH conditions: 90% RH on the sealant layer side of the film and 70% RH on the skin layer side of the film.

7. The film of claim 1 wherein the ratio between the total thickness of the at least one inner layer b) between the sealing layer a) and the barrier layer c), and the thickness of the barrier layer c) is between 0.5 and 2.8.

8. The film of claim 1 further comprising one or more additional inner layer(s) b) between the sealing layer a) and the barrier layer c).

9. The film of claim 1 wherein the outer skin layer d) comprises less than 40% by weight with respect to the weight of the skin layer d), of one or more polymers having water vapor transmission rate (WVTR) not higher than 8 g/sqm·day when measured according to ASTM F-1249 at 38° C. and 90% RH, on a flat cast extruded sample having a thickness of 50 microns.

10. The film of claim 1 wherein the outer skin layer d) comprises at least 70% by weight with respect to the weight of the skin layer d), of one or more polymers having water vapor transmission rate (WVTR) not higher than 8 g/sqm·day when measured according to ASTM F-1249 at 38° C. and 90% RH, on a flat cast extruded sample having a thickness of 50 microns,
wherein the ratio between the thickness of layer d) and the thickness of the at least one inner layer b) positioned between the sealing layer a) and the barrier layer c) is lower than 0.6.

11. The film of claim 9 wherein the one or more polymers of the outer skin layer d) having water vapor transmission rate (WVTR) not higher than 8 g/sqm·day when measured according to ASTM F-1249 at 38° C. and 90% RH, on a flat cast extruded sample having a thickness of 50 microns are selected among high-density polyethylene (HDPE), cyclic olefin copolymers (COC), polypropylene (PP) and mixtures thereof.

12. The film of claim 1 further comprising one or more bulk layers f) comprising one or more polymers selected among ethylene homo- and co-polymers, such as low density polyethylene (LDPE), ethylene-vinyl acetate copolymers (EVA), linear low density polyethylenes (LLDPE), linear very low density polyethylenes (VLDPE), ionomers and blends thereof.

13. The film of claim 1 having:
a number of layers comprised between 4 and 13, and
a total thickness from about 25 to about 180 microns.

14. The film of claim 1 having a free heat-shrinkage, in both the machine and transverse directions, of less than 15% as measured at 160° C. in oil according to ASTM D-2732.

15. The film of claim 1, wherein said film is cross-linked.

16. A vacuum skin package comprising a bottom support, a product loaded onto said support and a top film draped over the product and sealed over the entire surface of the support not covered by the product, wherein at least one of the bottom support and/or the top film is a coextruded, non-oriented, multilayer film suitable for use as top web in vacuum skin packaging (VSP) comprising at least:
an outer sealing layer a),
an inner barrier layer c) which comprises least 60% by weight with respect to the weight of layer c), of an ethylene vinyl alcohol (EVOH) copolymer,
at least one inner layer b) which comprises at least 70% by weight with respect to the weight of layer b) of one or more polymers having water vapor transmission rate (WVTR) not higher than 8 g/sqm·day, when measured according to ASTM F-1249 at 38° C. and 90% relative humidity (RH), on a flat cast extruded sample having a thickness of 50 microns, and
an outer skin layer d),
wherein:
said at least one inner layer b) is between the sealing layer a) and the barrier layer c);
no inner layers b) are present between the barrier layer c) and the outer skin layer d), and
the total thickness of the at least one inner layer b) between the sealing layer a) and the barrier layer c) is between 2% and 14% of the thickness of the whole film.

17. The vacuum skin package of claim 16, wherein the product is a food product.

18. The vacuum skin packaging of claim 16, in which the coextruded, non-oriented, multilayer film is the top film.

19. A vacuum skin packaging process, which comprises
providing a bottom support,
disposing a product onto the support,
providing a top film comprising an outer sealing layer, in which said outer sealing layer faces the support,
heating the top film and moulding it down upon and around the product and against the support, the space between the heated top film and the support having been evacuated to form a tight skin around the product, and
tight sealing said top film to the entire surface of the support not covered by the product by differential air pressure;
the top film being a coextruded, non-oriented, multilayer film suitable for use as top web in vacuum skin packaging (VSP) comprising at least:
an outer sealing layer a),
an inner barrier layer c) which comprises least 60% by weight with respect to the weight of layer c), of an ethylene vinyl alcohol (EVOH) copolymer,
at least one inner layer b) which comprises at least 70% by weight with respect to the weight of layer b) of one or more polymers having water vapor transmission rate (WVTR) not higher than 8 g/sqm·day, when measured according to ASTM F-1249 at 38° C. and 90% relative humidity (RH), on a flat cast extruded sample having a thickness of 50 microns, and
an outer skin layer d),
wherein:
said at least one inner layer b) is between the sealing layer a) and the barrier layer c);
no inner layers b) are present between the barrier layer c) and the outer skin layer d), and
the total thickness of the at least one inner layer b) between the sealing layer a) and the barrier layer c) is between 2% and 14% of the thickness of the whole film.

20. (canceled)

21. The film of claim 3, wherein layer b), does not comprise any polymers other than HDPE, low density polyethylene, ethylene-vinyl acetate copolymers, linear low density polyethylenes, linear very low density polyethylenes and ionomers.
